(19) United States
(12) Patent Application Publication
(10) Pub. No.: US 2004/0100546 A1
(43) Pub. Date: May 27, 2004

(54) System for transferring images to dark textiles

(75) Inventor: Tibor Horvarth, Vancouver (CA)

Correspondence Address: FOLEY AND LARDNER, SUITE 500, 3000 K STREET NW, WASHINGTON, DC, 20007, US

(73) Assignee: STAR COATING AG

(21) Appl. No.: 10/641,294

(22) Filed: Aug. 15, 2003

(30) Foreign Application Priority Data
Aug. 19, 2002 (EP) 02 018 167.3

(51) Int. Cl. B41J 2/01

(52) U.S. Cl. 347/105

(57) ABSTRACT

The present invention describes a system for transfer of images produced by an ink jet printer to a dark textile substrate, comprising

a backing substrate;

a first melt transfer layer applied to the backing substrate and comprising at least one meltable thermoplastic polymer material;

at least one ink absorption layer comprising a thermoplastic meltable polymer material into which fine particles of a filler material capable of ink absorption have been embedded;

at least one porous, ink-permeable contrast layer comprising a light-coloured or white pigment;

at least one second melt transfer layer comprising a meltable thermoplastic polymer material, this second layer being porous and permeable to ink.

The present invention relates to a means by which printed images, especially those produced using an ink jet printer, may be transferred to a dark textile substrate. The system allows the images to be applied by the action of heat and pressure, by means for example of an iron.

Systems with which printer-produced images may be applied to textile substrates such as articles of clothing, especially T-shirts and sweatshirts, bags and the like in a simple procedure are increasingly being demanded by the consumer. The reason for this is that a high percentage of households now possess a computer with a printer connected to it, in many cases a colour printer. The images produced by the computer can therefore be transferred without problems to a substrate, generally paper, using the printer. As a result of the electronic media nowadays available, in conjunction with current communication techniques, it is possible to produce images from a virtually infinite variety of sources. Digital still cameras, video cameras, and the Internet are just some of those that may be mentioned. It is obvious that many consumers foster the desire to print the images available via the computer and to transfer them to a textile substrate such as an item of clothing. This should be realizable as simply as possible.

For this purpose, the prior art proposes a variety of solutions.

U.S. Pat. No. 5,501,902 discloses a printable material consisting of a first support layer on which there is a second layer of a material which consists of a film-forming binder material and particles of a thermoplastic polymer with particle sizes of up to max. 50 μm. The particles consist of polyolefins, polyesters and ethylene-vinyl acetate copolymers. The printable material may be configured so that it is able to accept ink jet-printed images and to transfer them by the action of heat to a textile substrate. In this embodiment, an ink viscosity modifier is added; in order to achieve transferability to the substrate, the second layer includes a cationic polymer; in that case there is also, preferably, an additional melt transfer layer between the first support layer and the second layer.

DE 197 31 498 discloses an ink transfer sheet for applying ink jet-printed images to a textile substrate. The transfer sheet comprises a backing layer on which there is an interlayer of a meltable material which serves for fixing on the substrate. Above the interlayer there is an ink receiver layer on which there is applied in turn a layer of a quaternary ammonium salt, which serves to fix the ink.

Finally, WO 98/30749 discloses an ink transfer system comprising a substrate material, a melt transfer layer applied to the substrate material, and at least one ink-absorbing layer present on the said melt transfer layer. The ink-absorbing layer comprises a mixture of a highly porous filler and a binder, the molecules of the filler being capable of forming chemical bonds with the dye molecules of the ink. The fillers used are special highly porous polyamides which are intended to enter into a chemical bond with the dye.

The transfer systems described above are all suitable for application to light-coloured textiles. In the case of dark textiles, however, the colours of the print no longer emerge correctly, since the dark background formed by the textile masks the colours.

To solve this problem WO 00/73570 discloses an ink transfer system comprising a substrate material, a melt transfer layer applied to the substrate material, a light-coloured background layer present thereon, which cloaks the dark textile, and, in addition, at least one ink-absorbing layer present on the said background layer. The ink-absorbing layer comprises a mixture of a highly porous filler and a binder, the molecules of the filler being capable of forming chemical bonds with the dye molecules of the ink. The fillers used are special highly porous polyamides which are intended to enter into a chemical bond with the dye. In addition the melt transfer layer comprises dispersed therein spherical polyester particles of a size <30 μm, which are intended to produce better adhesion to the contrast layer. For the purpose of application the substrate material is removed, the system is placed by the melt transfer layer onto the textile, and, following placement of—preferably—baking paper onto the ink-absorbing layer, the protective transfer layer is melted with the iron.

This way of applying the printed image, however, is inconvenient. There is therefore a need for an ink transfer system which is suitable for use on dark textiles and whose application is just as easy to implement as the application of transfer systems for light-coloured textiles.

It is an object of the present invention to provide such a system.

This object is achieved by a system for transfer of images produced by an ink jet printer to a textile substrate, comprising

a backing substrate;

a first melt transfer layer applied to the backing substrate and comprising at least one meltable thermoplastic polymer material;

at least one ink absorption layer comprising a thermoplastic meltable polymer material into which fine particles of a filler material capable of ink absorption have been embedded;

at least one porous, ink-permeable contrast layer comprising a light-coloured or white pigment;

at least one second melt transfer layer comprising a meltable thermoplastic polymer material, this second layer being porous and permeable to ink.

This object is further achieved by a process for applying an image produced by an ink jet printer to a textile substrate, comprising the following steps:

mirror-inverted print application of an image to a transfer system of the invention;

placing of the system onto the textile substrate by the second melt transfer layer;

heating of the transfer system to a temperature at which the polymer material of the ink absorption layer melts;

peel removal of the backing substrate, after cooling has taken place;

if desired, implementation of a hot peel.

Further embodiments will become apparent from the description.

The system of the invention therefore has a structure in which a backing carries first a first melt transfer layer which serves for connection to the textile substrate. Since, preferably, during the application of the image obtained by the printing operation to the textile substrate, the backing remains on the system and is only removed thereafter, it is necessary for the backing to possess a certain heat resistance. Melting or even breakdown of the backing during application must be avoided. Consequently, the substrate must withstand the customary temperatures which are attained by the devices used in applying the system, such as irons or special presses. Preferably, the heat resistance of the backing must be situated at levels of ≧250° C.

Moreover, the backing is required to have abhesive properties (release properties), in order that it may be detached readily from the layer connected to it.

The backings used may be based on paper, polymer or textile. Examples of suitable backing materials include silicone paper, pseudosilicone paper (extra-smooth, blanched papers), wax paper, baking paper and polyesters. Preference is given to using siliconized paper or a pseudosilicone paper.

The first melt transfer layer comprises polymer or consists entirely of polymer.

The meltable polymer material establishes the connection to the fibre of the textile substrate, thereby ensuring secure transfer and secure adhesion of the image produced.

Suitable materials belong to the class of the thermoplastics. They are required to have a melting range which allows the material to melt on exposure to heat, which may be achieved with just a conventional iron, and in doing so establish the connection to the fibre. In general, this range is situated at levels of from 60 to 140° C., preferably from 70 to 120° C., in particular from 70 to 90° C.

As material for the matrix it is possible in principle to use all polymers which have an appropriate melting range and which possess the necessary properties of bonding to the filler material. Examples of suitable thermoplastics include polyesters, polyurethanes, ethylene-vinyl acetate copolymers, polyamides, e.g. nylon, epoxides, polyacrylates, styrene-butadiene copolymers, nitrile rubber, polyvinyl chloride, polyvinyl acetate, ethylene-acrylate copolymers, and ethylene-acrylate copolymers in combination with polyester. Preferred matrix materials are ethylene-acrylate copolymers, and ethylene-acrylate copolymers in combination with polyester.

The abovementioned materials may be used alone or in any desired combination with one another.

On the first melt transfer layer an ink absorption layer is then disposed, this layer serving to absorb the ink. The ink absorption layer has a polymer matrix into which a filler material, generally in particle form, has been embedded.

The meltable polymer material used as matrix material has properties of bonding, and hence serves as binder for the filler particles. Suitable materials belong to the class of the thermoplastics. They are required to have a melting range which allows the material to melt on exposure to heat, which may be achieved with just a conventional iron, and in so doing both to act as binder for the filler material and to establish the connection to the fibre. In general, this range is situated at levels of from 100 to 220° C., preferably from 120 to 200° C., in particular from 130 to 180° C.

As material for the matrix into which the filler material has been embedded it is possible in principle to use all polymers which have an appropriate melting range and which possess the necessary properties of bonding to the filler material. Examples of suitable thermoplastics include polyesters, ethylene-vinyl acetate copolymers, polyamides, nylon, epoxides, polyacrylates, styrene-butadiene copolymers, nitrile rubber, polyvinyl chloride, polyvinyl acetate, ethylene-acrylate copolymers, and ethylene-acrylate copolymers in combination with polyester. Preferred matrix materials are polyamides, ethylene-acrylate copolymers, and ethylene-acrylate copolymers, and ethylene-acrylate copolymers in combination with polyester. Particularly suitable are nylon polyamides, for example those sold under the trade name Elvamide® (Du Pont)

The abovementioned materials may be used alone or in any desired combination with one another.

The filler material embedded in the matrix material and present in the ink absorption layer serves to absorb the ink applied by the printer to the surface of the system. This material is generally in the form of particles which are surrounded by the matrix material and fixed by it. Suitable fillers for use in accordance with the present invention are organic and inorganic fillers or combinations within these types of filler or else combinations of the two types with one another. Suitable fillers are required to have appropriate ink absorption capacities and compatibility with the matrix material.

Examples of suitable organic fillers include melamine-formaldehyde resins, polyacrylates, polymethacrylates, polyurethanes, crosslinked polyvinylpyrrolidone, polyamides, formaldehyde resins and urea-formaldehyde resins.

Examples of commercially available polymers of the types mentioned above are given in the table below:

| Filler material type | Trade name |
|---|---|
| Melamine-formaldehyde resin | Pergopack ® M (Martinswerk GmbH, |
| | Bergheim, Germany) |
| Polyacrylate | Decosilk ® (Microchem, Uetikon, |
| | Switzerland) |
| Polyurethane | Decosoft ® (Microchem, Uetikon, |
| | Switzerland) |
| Organic polymers | Cerafluor ® 920 (Byk-Cera BV, |
| (urea compounds) | Deventer, Netherlands) |
| Polyvinylpyrrolidone | PVPP (ISP, New Jersey, USA) |
| Polyvinylpyrrolidone | Luvicross ® M (BASF AG, |
| | Ludwigshafen, Germany) |
| Polyamide | Orgasol ® (Atochem SA, France) |

Organic fillers used with preference are crosslinked polyvinylpyrrolidone and polyamides.

In particular, the polymers obtainable under the product names Orgasol® and Luvicross® M are suitable for the inventive utility.

The organic fillers are present in particle sizes of from 1 to 50 μm, preferably from 5 to 30 μm.

Examples of inorganic fillers include silicon dioxide in various modifications, Al₂O₃, TiO₂, BaSO₄ and aluminosilicates, preferably aluminosilicates and silicon dioxide. Preference is given to silicon dioxide obtainable under the name Klebosol® (Clariant) and CAB-O-SPERSE® (Cabot, USA) and also to aluminosilicates which are likewise available under the name CAB-O-SPERSE®.

In general, the inorganic fillers are likewise present in particle sizes of from 1 to 50 μm, preferably from 5 to 30 μm. It is, however, also possible for smaller particle sizes to be present. This is the case, for example, with fillers of the Klebosol and CAB-O-SPERSE® type, which are present in the form of particles with sizes from 1 to 100 nm.

The ink absorption layer comprising matrix material and filler possesses a layer thickness of from 20 to 100 μm, preferably from 30 to 50 μm.

Matrix material and filler are generally used in a matrix material/filler weight ratio (solids/solids) of from 1:1 to 1:10, preferably from 1:2 to 1:5, in the ink absorption layer.

In the simplest embodiment of the present invention, the ink absorption layer is homogeneous in construction and is applied in a single process step. In this case, therefore, there is only one single layer on the backing. It is, however, also possible to apply two or more ink absorption layers to the backing. In this case the layers may each have the same composition or may have different compositions.

Accordingly, it is possible, for instance, to implement a grading of the filler so that its concentration increases or decreases in one direction. It is also possible, for example, to implement a grading of the matrix material such that when a combination of two or more matrix materials is used the concentration of one or more materials decreases in one direction. The direction in which such a concentration gradient is chosen depends on a variety of factors known to the person skilled in the art: for example, on whether application takes place in inverse or normal function (see below), on the type of textile (for example cotton, cotton/PET blend, nylon, synthetic leather, etc.), on the type of transfer (iron or press), or on the ink used in the ink jet printer.

Even if there are two or more melt transfer ink absorption layers on the backing, the total thickness of the layers is within the range specified above of from 30 to 150 μm, preferably from 50 to 100 μm, in particular from 30 to 80 μm.

In one embodiment of the present invention, a dulling material is present in the transfer system of the invention. This dulling material is located on that surface of the ink absorption layer which faces the viewer after the printed system has been applied to a textile substrate. Consequently, if the printed system is applied by the inversion process, the dulling material is located on the surface of the ink absorption layer that faces the backing. If the image is applied by the normal process, the dulling material is located on the surface of this layer that faces away from the backing.

The dulling material may be incorporated in the surface of the ink absorption layer, or may be mounted thereon in an extra layer.

Dulling materials used are those organic and inorganic materials which are also used as fillers in the melt transfer ink absorption layer, i.e. melamine-formaldehyde resins, polyacrylates, polymethacrylates, polyurethanes, crosslinked polyvinylpyrrolidone, polyamides, silicon dioxide in various modifications, Al₂O₃, TiO₂, BaSO₄ and aluminosilicates. When selecting the dulling materials it should be borne in mind that the materials chosen must be non-meltable.

As the dulling material it is preferred to use one of the abovementioned inorganic fillers, especially synthetic amorphous silica, for example that under the trade names Sylojet® P 412 (particle size: 11.5 to 12.5 μm) and Sylojet® P 416 (particle size: 15 to 17 μm).

The fraction of these fillers in the region or in the layer in which they are used as dulling materials is chosen to be sufficiently high that a dulling effect is achieved. The fillers used as dulling material may be either identical with or different from the fillers used for ink absorption. These dulling effects may also be achieved by using a backing with a rough release surface, so that when it is peeled off a rough image surface is formed.

Besides the abovementioned layers, i.e. the backing layer, the melt transfer layer, the ink absorption layer and the optional dulling layer, there may be further layers in the system of the invention.

Disposed first on the ink absorption layers is a contrast layer, whose purpose is to provide a light-coloured or white background which allows the image to develop its colours properly. The dark background formed by the textile is covered.

The contrast layer must be permeable to ink and must not absorb it, or must do so only minimally, so that the ink can fully penetrate the contrast layer before being absorbed by the ink absorption layer and constituting the image. The contrast layer comprises an organic matrix material and also light-coloured or white pigments which serve to produce the contrast. The organic matrix material is a meltable material which on melting establishes a connection to the pigments and also to the layers situated above and below the contrast layer.

Suitable materials belong to the class of thermoplastics. They are required to have a melting range which allows the material to melt on exposure to heat, which may be achieved with just a conventional iron, and in doing so both to act as a binder for the pigment and to establish the connection to the fibre. In general, this range is situated at levels of from 100 to 220° C., preferably from 120 to 200° C., in particular from 130 to 180° C.

As material for the matrix into which the pigment material has been embedded it is possible in principle to use all polymers which have an appropriate melting range and which possess the necessary properties of bonding to the filler material. Examples of suitable thermoplastics include polyesters, ethylene-vinyl acetate copolymers, polyamides, nylon, epoxides, polyacrylates, styrene-butadiene copolymers and ethylene-acrylate copolymers in combination with polyester. Preferred matrix materials are polyamides, ethylene-acrylate copolymers, and ethylene-acrylate copolymers in combination with polyester. Nylon polyamides are used in particular, for example those sold under the trade name Elvamide®.

The abovementioned materials may be used alone or else in any desired combinations with one another. Suitable pigments are the customary light-coloured pigments known to the person skilled in the art, preferably those referred to as white pigments. Like the matrix material, the pigments must not absorb ink.

Suitable pigments include TiO₂ in anatase or rutile form, ZnS, ZnO, BaSO₄, those known as lithopones (combination of ZnS and BaSO₄), CaCO₃ or CaO.

The fraction of the pigments in the contrast layer is situated at levels of up to 95% by weight, preferably from 50 to 90% by weight, in particular from 60% to 80% by weight. The particle size of the pigments is situated generally at levels of from 10 to 60 μm, preferably from 10 to 30 μm.

As a further obligatory layer there is also a second melt transfer layer above the contrast layer. This second melt transfer layer, like the melt transfer layer disposed on the backing, is a layer comprising a hot melt adhesive which melts on exposure to heat and in doing so establishes a connection between textile and the transfer system that is to be applied. Through the use of the additional, second melt transfer layer the adhesion is improved as compared with a transfer system containing only one such layer.

The second melt transfer layer, which melts at higher temperatures than the first melt transfer layer, is composed of or comprises at least one hot melt adhesive. The melting points of the adhesive used in the second melt transfer layer are therefore generally situated above the melting points of the adhesive of the first melt transfer layer, and are in fact situated at from 80 to 180° C., preferably from 80 to 140° C., in particular from 100 to 120° C.

The hot melt adhesive and the second melt transfer layer must be permeable to ink and must not absorb ink. Accordingly the hot melt adhesive must be hydrophobic, just like any other materials present in the second melt transfer layer. Hot melt adhesives having the desired properties are known to the person skilled in the art.

The hot melt adhesive used in the second melt transfer layer is preferably a textile adhesive. Preferred materials of such textile adhesives are polyesters, poly-urethanes and styrene/butadiene latex. Good results have been achieved in particular with styrene/butadiene adhesives of the Reichhold® (origin: Swift) name, and especially good results with the adhesive of type Reichhold®TS 5113.

The transfer system of the invention is produced using the customary methods known to a person skilled in the art. In general, the polymers used as matrix material in each case are dissolved in an appropriate solvent. If another material is present in the layer, such as a filler, for instance, the polymer and the filler are dissolved or suspended with one another prior to mixing. Suitable solvents are known to a person skilled in the art and include water and alcohols, such as ethanol and isopropanol.

Combinations of these solvents may also be used. Preference is given to using an ethanol/water mixture.

Subsequently, the resulting solutions and/or suspensions are applied to the backing in the desired order by the customary methods and dried.

Further layers may be applied on top of the system thus obtained, if this is desired: the dulling layer is an example.

The application of an image to the desired textile substrate takes place as follows:

In one embodiment (inversion process), the image produced by the printer is printed in mirror inversion onto the transfer system of the invention. The system is then placed on the substrate in such a way that the second melt transfer layer is in contact with the substrate. The system is then applied to the substrate at temperatures at which the polymer used as matrix material melts, preferably by means of ironing or using a special press device. After cooling, the backing, which is at the top, is peeled off (cold peel), after which the printed image becomes visible. The inversion process is the preferred process for applying the transfer systems of the invention to textile.

After the cold peel it is also possible to carry out what is known as a hot peel. By this means it is possible, for example, to adjust the gloss of the surface (matt or gloss).

For the hot peel, a thin layer of a substrate, preferably standard paper or siliconized paper, is placed on the image obtained after the cold peel. The system is then heated above the melting point of the polymer used as matrix material, by ironing, for example. Thereafter the substrate is quickly peeled off. This generally achieves a better connection between the textile substrate and the matrix material.

In a further embodiment of the present invention, the image is printed without mirror inversion (normal process). In this case application takes place as in the inversion process, at which point first the backing layer is peeled off and the side of the transfer system on which the backing was is placed onto the substrate. Application of the image then takes place again by the action of heat and, where appropriate, pressure.

The inversion process is preferred over the normal process for the purposes of the present invention.

The invention is now illustrated in the following example:

Atop a melt transfer layer (hot melt layer) suitable and in accordance with the invention a layer (thickness: 30 μm) of 1:2 polyamide:Orgasol (solids/solids) in solution in ethanol is applied, and over that an ink-permeable contrast layer having a CaCO₃/polyamide ratio of 1:6 (solids/solids) at a thickness of 30 μm. Over that layer in turn is applied an ink-permeable melt transfer layer having a 1:1 polyamide:styrene/butadiene solids/solids ratio, with a thickness of 15 μm.

These mixtures are applied in succession to a 90 g/m² sheet of silicone paper (A4 format) and dried at 90° C. for 1 minute. The coated side is printed in a Canon S600 ink jet printer in “T-shirt transfer” mode. Thereafter, the image side with the printed pattern is placed on a T-shirt and transferred using an iron, with a transfer time of 60 seconds. The transfer temperature of the iron is given by the button setting “cotton”. The silicone paper is then peeled off.

1. System for transfer of images produced by an ink jet printer to a textile substrate, comprising
a backing substrate;
a first melt transfer layer applied to the backing substrate and comprising at least one meltable thermoplastic polymer material;
at least one ink absorption layer comprising a thermoplastic meltable polymer material into which fine particles of a filler material capable of ink absorption have been embedded;
at least one porous, ink-permeable contrast layer comprising a light-coloured or white pigment;
at least one second melt transfer layer comprising a meltable thermoplastic polymer material, this second layer being porous and permeable to ink.

2. System according to claim 1, wherein the meltable polymer in the first melt transfer layer is selected from the group consisting of polyesters, polyurethanes, ethylene-vinyl acetate copolymers, polyamides, nylon, epoxides, polyacrylates, styrene-butadiene copolymers, nitrile rubber, polyvinyl chloride, polyvinyl acetate, ethylene-acrylate copolymers, and ethylene-acrylate copolymers in combination with polyester, preferably from the group consisting of ethylene-acrylate copolymers, and ethylene-acrylate copolymers in combination with polyester.

3. System according to claim 1, wherein the melting range of the first melt transfer layer is situated at levels of from 60 to 140° C., preferably from 70 to 120° C., in particular from 70 to 90° C.

4. System according to claim 1, wherein the polymer material in the ink absorption layer is selected from the group consisting of polyesters, ethylene-vinyl acetate copolymers, polyamides, nylon, epoxides, polyacrylates, styrene-butadiene copolymers, nitrile rubber, polyvinyl chloride, polyvinyl acetate, ethylene-acrylate copolymers, and ethylene-acrylate copolymers in combination with polyester.

5. System according to claim 4, wherein the polymer material is selected from the group consisting of polyamides, ethylene-acrylate copolymers, and ethylene-acrylate copolymers, and ethylene-acrylate copolymers in combination with polyester.

6. System according to claim 4, wherein the polymer material is selected from nylon polyamides.

7. System according to of claim 1, wherein the melting range of the polymer material in the ink absorption layer is situated at levels of from 100 to 220° C., preferably from 120 to 200° C., in particular from 130 to 180° C.

8. System according to claim 1, wherein the filler material is selected from organic and inorganic materials from the group consisting of formaldehyde resins, melamine-formaldehyde resins, polyacrylates, polymethacrylates, polyurethanes, crosslinked polyvinylpyrrolidone, polyamides, silicon dioxide, Al₂O₃, TiO₂, BaSO₄ and aluminosilicates.

9. System according to claim 1, wherein the filler is an organic filler and is present in particle sizes of from 1 to 50 μm or the filler is an inorganic filler and is present in particle sizes of from 1 to 50 μm.

10. System according to claim 1, wherein matrix material and filler are present in a matrix material/filler weight ratio of from 1:1 to 1:10.

11. System according to claim 1, wherein the porous polymer in the contrast layer is selected from the group consisting of polyesters, ethylene-vinyl acetate copolymers, polyamides, nylon, epoxides, polyacrylates, styrene-butadiene copolymers and ethylene-acrylate copolymers in combination with polyester.

12. System according to claim 11, wherein the porous polymer is selected from nylon polyamides.

13. System according to claim 1, wherein the melting point of the polymer in the contrast layer is situated at levels of from 100 to 220° C.

14. System according to claims 1, wherein the pigment in the contrast layer is selected from the group consisting of TiO₂ in anatase and rutile form, ZnS, ZnO, BaSO₄, lithopones, CaCO₃ and CaO.

15. System according to claim 1, wherein the fraction of the pigments in the contrast layer is situated at levels of up to 95% by weight, and the particle size of the pigments is situated at levels of from 10 to 60 μm.

16. System according to claim 1 wherein the second melt transfer layer has a higher melting point than the first melt transfer layer.

17. System according to claim 1 wherein the thermoplastic polymer material of the second melt transfer layer is selected from the group consisting of textile adhesives, preferably from the group consisting of polyesters, polyurethanes and styrene/butadiene latex.

18. System according to claim 1 wherein the melting range of the polymer material in the second melt transfer layer is situated at levels of from 80 to 180° C.

19. System according to claim 1, wherein a backing of a material having abhesive properties is used which is selected from the group consisting of silicone paper, pseudosilicone paper, wax paper, baking paper and polyesters.

20. System according to claim 1, wherein the backing material has a heat resistance of at least 250° C.

21. Process for applying an image produced by an ink jet printer to a textile substrate, comprising the following steps:
mirror-inverted print application of an image to the transfer system according to claim 1;
placing of the system onto the textile substrate by the second melt transfer layer;
heating of the transfer system to a temperature at which the polymer material of the ink absorption layer melts;
peel removal of the backing substrate, after cooling has taken place;
if desired, implementation of a hot peel.

22. Process for applying an image produced by an ink jet printer to a textile substrate, comprising the following steps:
right-sided print application of the image produced by the computer to the transfer system according to claim 1,
peel removal of the backing,
placing of the system onto the textile substrate by that side of the melt transfer ink absorption layer on which the backing was,
heating of the transfer system to a temperature at which the matrix material melts,
peel removal of the backing, after cooling has taken place,
if desired, implementation of a hot peel.

23. Textile substrate, obtainable by applying an image produced by an ink jet printer to a textile substrate, in accordance with claim 21.

24. Textile substrate, obtainable by applying an image produced by an ink jet printer to a textile substrate, in accordance with claim 22.
